(19) United States
(12) Patent Application Publication
(10) Pub. No.: US 2023/0116580 A1
(43) Pub. Date: Apr. 13, 2023

(54) METHOD AND RELATED DEVICE FOR OPERATING IN A NON-TERRESTRIAL NETWORK (NTN)

(71) Applicant: FG Innovation Company Limited, Tuen Mun (HK)

(72) Inventors: CHIEN-CHUN CHENG, Taipei (TW); HSIN-HSI TSAI, Taipei (TW); CHIE-MING CHOU, Taipei (TW); HUNG-CHEN CHEN, Taipei (TW)

(21) Appl. No.: 17/908,318

(22) PCT Filed: Mar. 24, 2021
(86) PCT No.: PCT/CN2021/082843

§ 371 Date: Aug. 31, 2022

Related U.S. Application Data
(60) Provisional application No. 62/994,696, filed on Mar. 25, 2020.

(51) Int. Cl. H04W 72/231; H04W 72/21; H04W 74/02

(52) U.S. Cl. CPC H04W 72/231; H04W 72/21; H04W 74/02

(57) ABSTRACT

A method for a user equipment (UE) operating in a non-terrestrial network (NTN) is provided. The method includes receiving, from a base station (BS), assistance information; starting or restarting a timer upon receiving the assistance information; applying the assistance information to perform uplink synchronization; and determining that the UE has lost the uplink synchronization upon expiration of the timer.

### CROSS-REFERENCE TO RELATED APPLICATION(S)

The present disclosure is a National Stage application, filed under 35 U.S.C. § 371, of International Patent Application Serial No. PCT/CN2021/082843, filed on Mar. 24, 2021, which claims the benefit of and priority to U.S. Provisional Patent Application Ser. No. 62/994,696 filed on Mar. 25, 2020, entitled “UL frequency synchronization enhancements for earth fixed cell deployment in LEO based NTN.” The contents of all above-named applications are hereby fully incorporated herein by reference for all purposes.

### FIELD

The present disclosure is generally related to wireless communications and, more specifically, to a method and a related device for operating in a non-terrestrial network (NTN).

### BACKGROUND

With the tremendous growth in the number of connected devices and the rapid increase in user/network traffic volume, various efforts have been made to improve different aspects of wireless communication for the next-generation wireless communication system, such as the fifth-generation (5G) New Radio (NR) system, by improving data rate, latency, reliability, and mobility.

The 5G NR system is designed to provide flexibility and configurability for optimizing the network services and types, accommodating various use cases such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communication for the next-generation wireless communication system.

### SUMMARY

The present disclosure provides a method and a related device for operating in a non-terrestrial network (NTN).

In a first aspect of the present disclosure, a method for a user equipment (UE) operating in an NTN is provided. The method includes receiving, from a base station (BS), assistance information; starting or restarting a first timer upon receiving the assistance information; applying the assistance information to perform uplink synchronization; and determining that the UE has lost the uplink synchronization upon expiration of the first timer.

In an implementation of the first aspect, the method further includes determining that the assistance information is invalid upon the expiration of the first timer.

In an implementation of the first aspect, the method further includes treating other running timers associated with the uplink synchronization as expired upon the expiration of the first timer.

In an implementation of the first aspect, the method further includes flushing all hybrid automatic repeat request (HARM) buffers for at least one serving cell upon the expiration of the first timer.

In an implementation of the first aspect, the method further includes notifying a radio resource control (RRC) layer of the UE to release a physical uplink control channel (PUCCH) for at least one serving cell upon the expiration of the first timer.

In an implementation of the first aspect, the method further includes notifying a radio resource control (RRC) layer of the UE to release a sounding reference signal (SRS) for at least one serving cell upon the expiration of the first timer.

In an implementation of the first aspect, the method further includes clearing a configured downlink assignment and a configured uplink grant for at least one serving cell upon expiration of the timer.

In an implementation of the first aspect, the method further includes clearing a physical uplink shared channel (PUSCH) resource for semi-persistent channel state information (CSI) reporting for at least one serving cell upon the expiration of the first timer.

In a second aspect of the present disclosure, a UE operating in an NTN is provided. The UE includes a processor configured to execute a computer-executable program, and a memory, coupled to the processor and configured to store the computer-executable program. The computer-executable program, when executed by the processor, causes the UE to: receive, from a BS, assistance information; start or restart a first timer upon receiving the assistance information; apply the assistance information to perform uplink synchronization; and determine that the UE has lost the uplink synchronization upon expiration of the first timer.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating a Non-terrestrial network (NTN) with a Low Earth Orbiting (LEO) satellite, according to an implementation of the present disclosure.

FIG. 2 is a graph illustrating an evaluation of Doppler shift for a LEO satellite in S-band.

FIG. 3 is a diagram illustrating a pre-compensation of common frequency shift, according to an implementation of the present disclosure.

FIG. 4 is a diagram illustrating Doppler frequency shift for uplink (UL) transmission, according to an implementation of the present disclosure.

FIG. 5 is a diagram illustrating a satellite beam covering several earth-fixed cells, according to an implementation of the present disclosure.

FIG. 6 is a diagram illustrating UL Doppler frequency offsets, according to an implementation of the present disclosure.

FIG. 7 is a flowchart illustrating a method of initial access for a user equipment (UE), according to an implementation of the present disclosure.

FIG. 8 is a block diagram illustrating a node for wireless communication, according to an implementation of the present disclosure.

### DESCRIPTION

The following disclosure contains specific information pertaining to exemplary implementations in the present disclosure. The drawings and their accompanying detailed disclosure are directed to exemplary implementations. However, the present disclosure is not limited to these exemplary implementations. Other variations and implementations of the present disclosure will occur to those skilled in the art. Unless noted otherwise, like or corresponding elements in the drawings may be indicated by like or corresponding reference numerals. Moreover, the drawings and illustrations are generally not to scale and are not intended to correspond to actual relative dimensions.

For consistency and ease of understanding, like features are identified (although, in some examples, not shown) by reference designators in the exemplary drawings. However, the features in different implementations may be different in other respects, and therefore shall not be narrowly confined to what is shown in the drawings.

The phrases “in one implementation,” and “in some implementations,” may each refer to one or more of the same or different implementations. The term “coupled” is defined as connected, whether directly or indirectly via intervening components, and is not necessarily limited to physical connections. The term “comprising” may mean “including, but not necessarily limited to” and specifically indicate open-ended inclusion or membership in the disclosed combination, group, series, and equivalents.

The term “and/or” herein is only an association relationship for describing associated objects and represents that three relationships may exist, for example, A and/or B may represent that: A exists alone, A and B exist at the same time, and B exists alone. “A and/or B and/or C” may represent that at least one of A, B, and C exists. Besides, the character “/” used herein generally represents that the former and latter associated objects are in an “or” relationship.

Additionally, any two or more of the following paragraphs, (sub)—bullets, points, actions, behaviors, terms, alternatives, examples, or claims in the present disclosure may be combined logically, reasonably, and properly to form a specific method. Any sentence, paragraph, (sub)—bullet, point, action, behaviors, terms, or claims in the present disclosure may be implemented independently and separately to form a specific method. Dependency, e.g., “based on”, “more specifically”, “preferably”, “In one embodiment”, “In one implementation”, “In one alternative”, in the present disclosure may refer to just one possible example that would not restrict the specific method.

For a non-limiting explanation, specific details, such as functional entities, techniques, protocols, standards, and the like, are set forth for providing an understanding of the disclosed technology. In other examples, detailed disclosure of well-known methods, technologies, systems, and architectures are omitted so as not to obscure the present disclosure with unnecessary details.

Persons skilled in the art will recognize that any disclosed network function(s) or algorithm(s) may be implemented by hardware, software, or a combination of software and hardware. Disclosed functions may correspond to modules that may be software, hardware, firmware, or any combination thereof. The software implementation may comprise computer-executable instructions stored on a computer-readable medium, such as memory or other types of storage devices. For example, one or more microprocessors or general-purpose computers with communication processing capability may be programmed with corresponding executable instructions and carry out the disclosed network function(s) or algorithm(s). The microprocessors or general-purpose computers may be formed of Application-Specific Integrated Circuits (ASICs), programmable logic arrays, and/or one or more Digital Signal Processors (DSPs). Although some of the disclosed implementations are directed to software installed and executing on computer hardware, nevertheless, alternative implementations, such as firmware, as hardware, or as a combination of hardware and software, are well within the scope of the present disclosure.

The computer-readable medium may include, but may not be limited to, Random Access Memory (RAM), Read-Only Memory (ROM), Erasable Programmable Read-Only Memory (EPROM), Electrically Erasable Programmable Read-Only Memory (EEPROM), flash memory, Compact Disc (CD) Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a New Radio (NR) system) may typically include at least one base station (BS), at least one UE, and one or more optional network elements that provide connection with a network. The UE may communicate with the network (e.g., a Core Network (CN), an Evolved Packet Core (EPC) network, an Evolved Universal Terrestrial Radio Access Network (E-UTRAN), a Next-Generation Core (NGC), a 5G Core (5GC), or an internet) via a Radio Access Network (RAN) established by one or more BSs.

A UE according to the present disclosure may include, but is not limited to, a mobile station, a mobile terminal or device, or a user communication radio terminal. For example, a UE may be a portable radio equipment that includes, but is not limited to, a mobile phone, a tablet, a wearable device, a sensor, or a Personal Digital Assistant (PDA) with wireless communication capability. The UE may be configured to receive and transmit signals over an air interface to one or more cells in a RAN.

A BS may include, but is not limited to, a node B (NB) as in the Universal Mobile Telecommunication System (UMTS), an evolved node B (eNB) as in the LTE-A, a Radio Network Controller (RNC) as in the UMTS, a Base Station Controller (BSC) as in the Global System for Mobile communications (GSM)/GSM Enhanced Data rates for GSM Evolution (EDGE) RAN (GERAN), a next-generation eNB (ng-eNB) as in an Evolved Universal Terrestrial Radio Access (E-UTRA) BS in connection with the 5GC, a next-generation Node B (gNB) as in the 5G-RAN (or in the 5G Access Network (5G-AN)), and any other apparatus capable of controlling radio communication and managing radio resources within a cell. The BS may connect to serve the one or more UEs via a radio interface to the network.

ABS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UMTS (often referred to as 3G) according to basic Wideband-Code Division Multiple Access (W-CDMA), High-Speed Packet Access (HSPA), LTE, LTE-A, enhanced LTE (eLTE), NR (often referred to as 5G), and/or LTE-A Pro. However, the scope of the present disclosure is not limited to these protocols.

The BS may be operable to provide radio coverage to a specific geographical area using a plurality of cells forming the RAN. The BS may support the operations of the cells. Each cell may be operable to provide services to at least one UE within its radio coverage. More specifically, each cell (often referred to as a serving cell) may provide services to serve one or more UEs within its radio coverage, (e.g., each cell schedules the downlink (DL) and optionally UL resources to at least one UE within its radio coverage for DL and optionally UL packet transmissions). The BS may communicate with one or more UEs in the radio communication system via the plurality of cells.

A cell may allocate Sidelink (SL) resources for supporting Proximity Service (ProSe), LTE SL services, and LTE/NR Vehicle-to-Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As disclosed previously, the frame structure for NR is to support flexible configurations for accommodating various next-generation (e.g., 5G) communication requirements, such as eMBB, mMTC, and URLLC, while fulfilling high reliability, high data rate, and low latency requirements. The orthogonal frequency-division multiplexing (OFDM) technology, as agreed in the 3rd Generation Partnership Project (3GPP), may serve as a baseline for an NR waveform. The scalable OFDM numerology, such as the adaptive sub-carrier spacing, the channel bandwidth, and the cyclic prefix (CP), may also be used. Additionally, two coding schemes are applied for NR: (1) low-density parity-check (LDPC) code and (2) polar code. The coding scheme adaption may be configured based on the channel conditions and/or the service applications.

Moreover, in a transmission time interval of a single NR frame, at least DL transmission data, a guard period, and UL transmission data should be included. The respective portions of the DL transmission data, the guard period, and the UL transmission data should also be configurable, for example, based on the network dynamics of NR. An SL resource may also be provided via an NR frame to support ProSe services or V2X services.

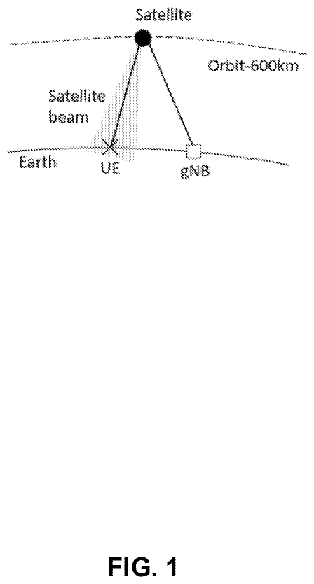

Non-terrestrial networks (NTN) refer to networks, or segments of networks, which use a spaceborne vehicle for transmission (e.g., using Low Earth Orbiting (LEO) satellites). FIG. 1 is a diagram illustrating an NTN network with a LEO satellite, according to an implementation of the present disclosure.

In 3GPP Release 17 (Rel-17) NTN working item (WI), a transparent payload-based LEO scenario addressing at least 3GPP class 3 UEs with Global Navigation Satellite System (GNSS) capability and with both Earth fixed beam (EFB) and Earth moving beam (EMB) footprint has been prioritized.

A transparent payload-based LEO network (NW) refers to a relay-based NTN. In this case, LEO satellites simply perform amplify-and-forward operations in space, and the BS (e.g., gNB) is located on the ground connected to a core NW. As illustrated in FIG. 1, a LEO satellite of a transparent payload-based NW is at orbit 600 km.

3GPP class 3 UE refers to Power Class UE 3. The definition is used for a UL transmit (TX) power level set to be 23 dBm with a range of plus and minus 2 dB. This setting was mainly driven to ensure backward compatibility with prior technologies (e.g., Rel-15 NR/GSM/UMTS), so that network deployment topologies remain similar.

GNSS refers to a standard generic term for satellite navigation systems that provide autonomous geo-spatial positioning with global coverage. This term includes the Global Positioning System (GPS), GLONASS, Galileo, Beidou and other regional systems.

EMB refers to footprints of satellite beams on earth are moving with satellite. Cells on the ground are serviced by different beams with the satellite rotation.

EFB refers to footprints of satellite beams on earth are fixed for a long time. The angle of an antenna for each beam is adjusted during the moving of a satellite to provide service to a fixed area on earth for a long time. The major difference to the EMB situation is that a round trip time (RTT) for a statistic device is varying with the elevation angle of beams, and each cell/area has the largest RTT with the minimum or maximum elevation angle.

In this disclosure, the EFB deployment is applied, which simplifies the inter-cell mobility by extending the cell serving time. Moreover, as cells are fixed on the ground, tracking areas are fixed and an update mechanism can be simple.

In addition, a UE with GNSS has the capability of timing and frequency estimation and compensation. Several issues affecting an initial access of the UE are disclosed as follows.

Issue 1: DL Synchronization

In NR, a UE detects a primary synchronization signal (PSS) and a secondary synchronization signal (SSS). Those synchronization signals allow time and frequency correction, and cell identity detection. The UE may get good one-shot detection probability with less than 1% false alarm rate with robustness against initial frequency offset up to 5 parts per million (ppm) (e.g., 10 kHz for S-band (2 GHz)).

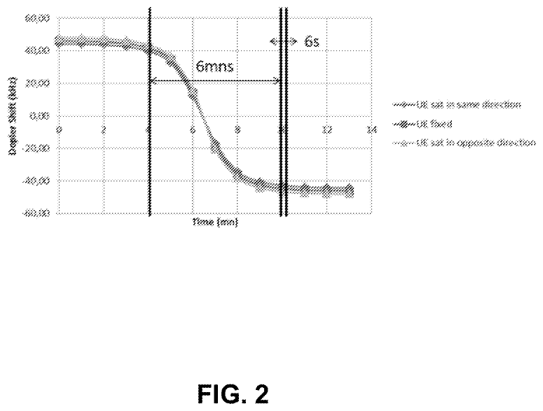

FIG. 2 is a diagram illustrating an evaluation of Doppler shift for a LEO satellite in S-band. FIG. 2 illustrates a case of 2 gigahertz (GHz) signal at 600 kilometers (km) on DL and UL for a fixed UE and a UE in motion (e.g., in the same direction or in the opposite direction to the LEO satellite). It shows up to 48 kilohertz (kHz) Doppler shift in DL for the whole satellite coverage, which is not covered in a coverage defined in the 3GPP Rel-15 NR. Another issue is the Doppler variation during the service period. For EFB, the connected period is around 6 minutes (mn), and the UE may experience the maximum and the minimum Doppler shift from +48 kHz to −48 kHz. However, for EMB, the connected period is nearly 6 seconds, and the Doppler shift variation can be ignored compared to 10 kHz.

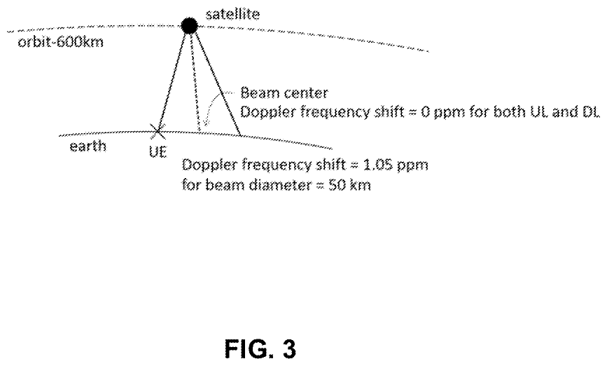

Therefore, a pre-compensation at the satellite side with beam-specific pre-compensation of common frequency shift (e.g., conducted to the spot beam center at the NW side) may be applied. FIG. 3 is a diagram illustrating a pre-compensation of common frequency shift, according to an implementation of the present disclosure. In FIG. 3, for each beam center, the Doppler frequency shift is 0 ppm for both UL (or called post-compensation at the satellite side) and DL, whereas the maximum residual Doppler shift (e.g., 1.05 ppm) happens for a UE at the beam edge.

If the pre-compensation mechanism is applied at the satellite side, the max Doppler shift and the max Doppler rate are shown in Table 1. Except for the extreme case (e.g., the beam diameter of 1000 km), the robust performance can be provided by the PSS and SSS in 3GPP Rel-15 NR. Table 1 shows maximum Doppler shift and rate with pre/post compensation mechanism.

TABLE 1

| | |
|---|---|
| Max Doppler | for 600 km satellite altitude |
| shift without | 24 ppm |
| pre/post | |
| compensation | |
| Max Doppler | for 600 km satellite altitude |
| shift with | beam diameter = 50 km (Set 1 - S-band): 1.05 ppm |
| pre/post | beam diameter = 90 km (Set 2 - S-band): 1.88 ppm |
| compensation | beam diameter = 1000 km (max beam footprint size): |
| | 15.82 ppm |
| Max Doppler | 0.27 ppm/s for 600 km satellite altitude |
| rate | |

If the pre-compensation mechanism is not mandatory to be applied for initial DL synchronization, a cost of increasing receiver complexity may occur due to the increased number of frequency hypotheses. For example, with a subcarrier spacing of 15 kHz, the number of frequency hypotheses with pre-compensation is about 6 and the number without pre-compensation is 18.

Issue 2: Random Access Channel (RACH)

If a pre-compensation of timing and frequency offset at the UE side for a UL transmission is applied, physical random access channel (PRACH) formats and preamble sequences in the 3GPP Rel-15 NR can be reused.

However, for the transparent scenario, the UE may have difficulty estimating the UL Doppler shift for the feeder link, and thus the NW may indicate assistant information (e.g., gNB location) to the UE for the estimation. On the other hand, the Doppler shift due to the feeder link may be ignored during the evaluation for the system-level simulation. This concept may be implemented, as the Doppler frequency shift of the feeder link is perfectly compensated by the satellite, such that the UE only needs to pre-compensate the UL frequency shift caused by a service link.

Another issue is that if the beam-specific post-compensation of the common frequency offset is applied at the NW side, the UE may need to calculate the residual UL frequency offset. The residual UL frequency offset refers to the Doppler shift difference between the common UL Doppler shift and the UE-specific Doppler shift, for sending a PRACH preamble. It is noted that even if the UE can estimate the UE-specific Doppler shift including the impacts from both the service link and the feeder link, the UE may still have difficulty estimating the residual UL frequency offset without knowing the common frequency offset used at the NW side. Thus, in this case, assistant information from the NW to the UE may be needed.

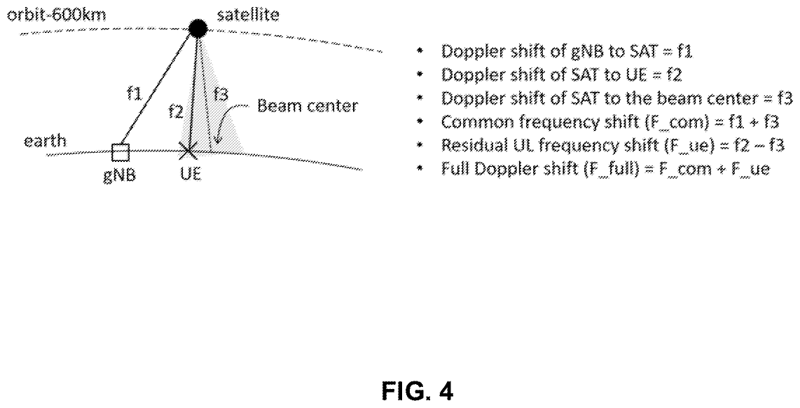

FIG. 4 is a diagram illustrating Doppler frequency shift for UL transmission, according to an implementation of the present disclosure. In FIG. 4, Doppler frequency shift for a PRACH transmission is illustrated. For the PRACH, the UE experiences the full Doppler frequency shift (F_full) caused by the feeder link (f1) and the service link (f2). The value of F_full can be taken apart into the cell-specific common part (F_com) and the UE-specific differential part (F_ue) (e.g., F_full=f1+f2=F_com+F_ue). For the cell-specific common part (F_com), it composes the impact of the feeder link (f1) and the service link to the beam center (f3) (e.g., F_com=f1+f3). For the UE-specific differential part (F_ue), it presents a gap between the Doppler frequency shift of the service link (f2) and that of the service link to the beam center (f3) (e.g., F_ue=f2−f3).

The UE may pre-compensate F_full if the post-compensation is applied at the NW side, or F_ue if there is no post-compensation for the PRACH transmission. However, only f2 can be estimated by the UE with GNSS and satellite ephemeris. Therefore, the NW may provide additional information for f1 and f3.

Issue 3: Maintenance for UL Frequency Synchronization

After a UE completes a RACH procedure, the UE is in an RRC CONNECTED mode (or called RRC CONNECTED mode). The NW may maintain the UE-specific UL frequency synchronization. In RRC CONNECTED mode, only the case for the post-compensation at the NW is disclosed. The case of no post-compensation is not disclosed. Both cases are applied for the PRACH transmission.

However, pre-compensation and post-compensation cannot be decoupled. For example, the NW only supports the pre-compensation for the DL, but does not support the post-compensation for the UL. This is because when the NW enables the pre-compensation for sending a Synchronization Signal Block (SSB), the UE cannot estimate the absolute Doppler frequency shift for the PRACH transmission. In an example, the absolute Doppler shift may be estimated via GNSS and satellite ephemeris. However, the DL signal would be useless for frequency tracking. If pre-compensation is enabled, the NW has to apply the post-compensation for receiving the PRACH preambles. As above-mentioned DL synchronization section, the pre-compensation is essential for the robust DL synchronization. Thus, the post-compensation at the NW side for at least the PRACH transmission is unavoidable.

Another observation is that the compensation mechanism may be aligned for PRACH transmission, and the maintenance for physical uplink shared channel (PUSCH), sounding reference signal (SRS), or physical uplink control channel (PUCCH) transmission. This is because if the post-compensation is only applied for the initial access but not for the UL maintenance, the PRACH preamble from one UE may interfere with UL transmission from another UE in the same serving cell. Hence, the post-compensation at the NW side for both the PRACH transmission and the UL maintenance is unavoidable.

If the Doppler pre-compensation and the post-compensation are applied at the satellite side, for initial DL synchronization, significant complexity may be required for the maximum beam size of 1000 km, but no additional complexity is needed for reference beam sizes, such as 50 km and 90 km. In this case, a new indication from the NW to inform the UE for different decoding complexity may be needed.

For RACH, if no UL frequency synchronization of the feeder link is maintained by the NW, the UE may need some additional NW assistant information with UE GNSS and satellite ephemeris to calculate the UE-specific UL frequency.

For a UE in RRC CONNECTED mode, if autonomous pre-compensation at the UE is supported, regulation may be needed regarding UE capability and legal regulation on UL frequency use. Also, the UE may require a new capability report to avoid connecting to a new cell with a large beam size beyond its capability.

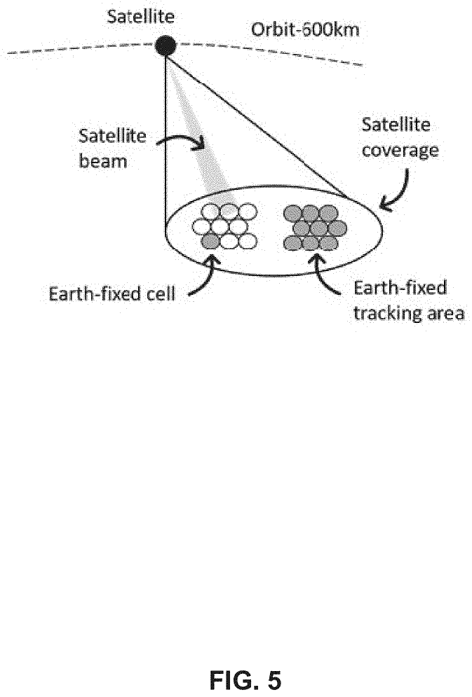

FIG. 5 is a diagram illustrating a satellite beam covering several earth-fixed cells, according to an implementation of the present disclosure. A satellite cell may not span partially over multiple countries, because the associated Public Land Mobile Network (PLMN) may not cross the border. As a result, a satellite beam may contain multiple cells, where each cell is fixed on the ground. If a given satellite beam covers several cells, then the beam-specific procedures and parameters may be shared across cells or carrier components.

For initial DL synchronization as mentioned in Issue 1, some observations are disclosed.

1. Beam-specific pre-compensation of common frequency shift may be essential.

2. Except for the case of beam diameter 1000 km, no enhancement may be needed for DL synchronization if the pre-compensation of common frequency shift is deployed.

3. For EFB, the pre-compensated value may be adjusted with time since the radial velocity between the satellite and the beam center may be consistently changing.

4. The pre-compensation of the common frequency shift may be transparent to UEs.

Based on the observations, the following operations may be applied:

1. For the extreme case of diameter 1000 km or no pre-compensation, a new indication from a NW to a UE may be beneficial for preparing additional decoding complexity.

2. The pre-compensation of the common frequency shift and the DL Doppler frequency shift caused by the feeder link may be up to NW implementation.

3. A UE performs a cell search procedure to acquire time and frequency synchronization with a cell and detects the cell identity (ID) of that cell. The cell search is based on the primary and secondary synchronization signals, and Physical Broadcast Channel (PBCH) Demodulation Reference Signal (DMRS), located on the synchronization raster.

4. A UE Non-Access-Stratum (NAS) layer may identify whether a selected PLMN is associated with the NTN. If the UE determines the selected PLMN belongs to the NTN, the UE may attempt to find a suitable NTN cell in a manner of increasing the number of frequency hypotheses at the cost of complexity.

For a cell selection, the UE NAS layer identifies a selected PLMN and equivalent PLMNs. Cell selection may be always based on Cell-Defining SSBs (CD-SSBs) located on the synchronization raster. The UE searches NR frequency bands and, for each carrier frequency, identifies the strongest cell as per the CD-SSB, and then reads cell system information broadcast to identify its PLMN(s). In one example, the UE may search each carrier in turn (e.g., initial cell selection) or make use of stored information to shorten the search (e.g., stored information cell selection). If the selected PLMN(s) belong to the NTN, the UE may search the carriers in an increased number of frequency hypotheses. If an NTN cell is identified (e.g., a specific format of PSS or SSS or a specific GNSS information and satellite ephemeris), the UE may search the carriers in an increased number of frequency hypotheses. In addition, the UE may seek to identify a suitable cell. However, if the UE is not able to identify a suitable cell, the UE may seek to identify an acceptable cell.

On the other hand, if it is not for the initial cell selection (e.g., if a UE has already camped on a cell, and/or a UE enters RRC IDLE/INACTIVE/CONNECTED state), the UE may be provided each serving cell with an indication (e.g., NTNadditonalComplexity) from a NW via an RRC message (e.g., System Information Block 1 (SIB1)), for the reception of the SSBs for the serving cell by an increased number of frequency hypotheses. More specifically, any other system information may also be possible to be used for transmitting the indication. For another example, the UE may be provided with NTNadditonalComplexity from the NW via a dedicated RRC configuration. More specifically, the indication may include 1-bit information, where ‘1’ refers to additional decoding complexity is needed; otherwise, ‘0’ refers to no additional complexity is required. The UE may send an NTN service request to the cell, and thus the cell provides NTNaditionalComnplexity through a dedicated RRC signal (unicast transmission) or a dedicated SIB (broadcast transmission). In one example, the dedicated SIB is used to specifically provide neighboring cell information on an additional complexity requirement as mentioned above, via a broadcast signal.

Moreover, a handover (HO) procedure is disclosed. In NTN, the message of “measurement report” from the UE to a source gNB may not be necessary when a measurement event is triggered at the UE side. This is because 1) the Reference Signal Received Power (RSRP) between the cell center and the cell edge may be the same, and 2) when the feeder link switch occurs, an HO is necessary regardless of the measurement report.

For example, the NTNadditonalComplexity may be carried by the message of RRCReconfiguration from the source gNB to the UE. The RRCReconfiguration message includes at least a cell ID and all information required to access a target cell, so that the UE can access the target cell without reading system information. For some cases, the information required for contention-based and contention-free random access can be included in the RRCReconfiguration message. It is noted that, for an NTN, this message may further indicate whether the target cell is an NTN cell or a terrestrial network (TN) cell, or the type of NTN platforms (Geostationary Earth Orbit (GEO) or LEO), or synchronization information (e.g., timing advance, timing stamp for the target SSBs, and/or UL frequency indications).

For RACH, as mentioned in Issue 2, some observations are disclosed.

1. In simulation calibrations, the Doppler frequency shift for the feeder link may be ignored.

2. Different from Timing Advance (TA), a NW does not need to know the absolute Doppler frequency shift for scheduling.

3. If_UL frequency and timing can be pre-compensated by a UE, no new PRACH format is needed.

4. A UE may have difficulty estimating the Doppler frequency shift for the feeder link. NW assistant information may be needed (e.g., signaling the gateway (GW) locations or the Doppler frequency shift value).

5. If the Doppler frequency shift of the feeder link can be compensated by a satellite, a UE may only need to pre-compensate the Doppler frequency shift of the service link.

6. If the beam-specific post-compensation of common frequency offset at the NW side is applied and if the Doppler frequency shift of the feeder link is compensated, a UE may still need NW assistant information to calculate the residual UL frequency offset for sending a preamble on PRACH.

7. For the EFB, if the NW assistant information refers to the common post-compensation of common frequency offset, it may need to be broadcast per cell and to be updated with time.

Based on the observations, the following operations may be applied:

1. A UE may calculate the residual UL frequency offset with NW assistant information.

2. If UE can estimate the Doppler frequency shift of the service link, some components for estimating the residual UL frequency offset include:

a. the beam-specific post-compensation of common frequency offset value of the service link;

b. the geometric location of the beam center (e.g., a reference point) on the ground;

c. the GW location and the location of the reference point;

d. the GW location and the beam-specific post-compensation of the common frequency offset value used at the NW side.

The NW assistant information may be implemented as a periodic event carried by system information (SI), where the NW may refer to a BS or a gNB, or may refer to a gateway (GW) in the NTN. The NW assistant information may have the unit or granularity in absolute kHz, or multiple numbers (including 1) of PRACH subcarrier spacing (e.g., 1.25 kHz), or a fraction expression of PRACH subcarrier spacing, or a number of resource blocks (RBs) defined by 3GPP Rel-15 NR.

In 3GPP Rel-17 NTN, a UL frequency pre-compensation procedure may be applied. A UE may apply a new UL frequency offset for the PRACH preamble transmission, based on NW assistant information in system information (e.g., SIB1), UE GNSS, and/or satellite ephemeris. Moreover, a new PRACH preamble group may be applied, where the new PRACH preamble group may support a larger range of the frequency offset to accommodate the requirement in the NTN.

In detail, operations of a UL frequency compensation procedure are disclosed.

A UE may initiate the UL frequency compensation procedure for PRACH preamble transmission if the UE determines an NTN service such that a selected PLMN(s) is associated with the NTN service, and/or the selected cell belongs to an NTN serving cell set that includes NTN cell IDs that are configured or pre-configured by the NW.

The UL frequency compensation procedure is initiated by a random access (RA) procedure (e.g., a PDCCH order), by a Media Access Control (MAC) entity of the UE, or by an RRC message. For example, when the UE initiates an RA procedure, the UE may determine whether to initiate the UL frequency compensation procedure based on if the selected PLMN(s) is associated with NTN service and/or if the selected cell belongs to an NTN serving cell set.

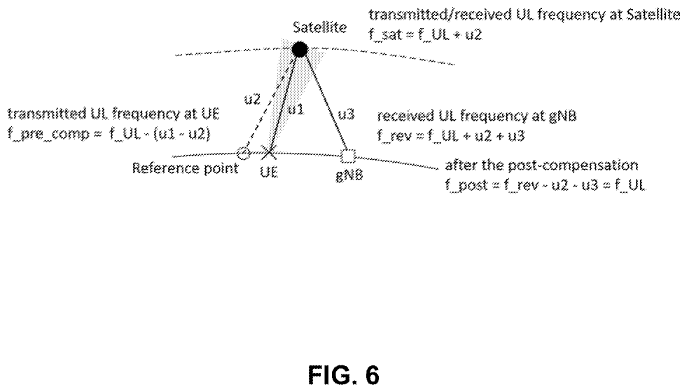

FIG. 6 is a diagram illustrating UL Doppler frequency offsets, according to an implementation of the present disclosure. As illustrated in FIG. 6, UL Doppler frequency offsets due to satellite movement include the following components:

1. the UL Doppler frequency offset (or called UL Doppler frequency offset value) from the UE to the satellite (namely service link): u1

2. the UL Doppler frequency offset (or called cell-specific common UL frequency offset value) of the reference point (e.g., a serving beam center) to the satellite: u2

3. the UL Doppler frequency offset of the satellite to gNB (namely feeder link): u3

4. post-compensation at a NW: u2+u3 (e.g., zero UL Doppler frequency offset at the beam center)

5. pre-compensation at UE: u1−u2

In addition, a NW configures the following parameters for the UL frequency compensation procedure to a UE via an RRC message:

1. prach-ConfigurationIndex: the available set of PRACH occasions for the preamble transmission;

2. commonULfrequencyOffset: the UL Doppler frequency offset u2 that is calculated based on a fixed reference point on the ground (e.g., the serving beam center on the ground) and the movement of the serving satellite (e.g., satellite speed and location). The UL Doppler frequency offset may be time-varying and may be updated via a broadcast signal. The commonULfrequencyOffset may provide a list of absolute values in kHz, numbers for Physical Resource Block (PRB) indexes, or numbers for frequency band indexes.

On the other hand, the UE transmits the following parameters for UE capability information to the NW via an RRC message when the UE receives an RRC message of UECapabilityEnquiry from the NW:

1. UECapabilityInformation: the UECapabilityInformation message is used for transmitting UE radio access capabilities requested by the NW;

2. ULfrequencyCompensation: if this field is present, the UE supports the UL frequency pre-compensation for UL transmission including PRACH preamble transmission.

Therefore, when the UL frequency compensation procedure is initiated by a UE on a serving cell, the UE calculates the UL Doppler frequency offset u1 based on UE GNSS and satellite ephemeris. The UE derives the UL Doppler frequency offset u2, or UE reads the value of u2 in system information configured from the NW via SIB 1. In addition, the UE performs the pre-compensation by sending a PRACH preamble on frequency f_pre_comp=f_UL−(u1−u2), where f_UL is a UL frequency for the transmission of a PRACH preamble selected from an available set of PRACH occasions.

When a gNB provides an NTN cell, the gNB indicates the UL Doppler frequency offset u2 via a broadcast signal (e.g., SIB1). The gNB configures the available set of PRACH occasions (e.g., UL frequency) to the UE. The gNB receives the PRACH preamble on frequency f_rev=f_UL−(u1−u2)+u1+u3=f_UL+u2+u3. Therefore, the gNB performs the post-compensation on the received PRACH preamble as f_post=f_rev−u2−u3=f_UL.

It is noted that the satellite does not perform compensation, where f sat is the received UL frequency and the transmitted UL frequency at the serving satellite.

If no commonULfrequencyOffset for proving u2 (e.g., the commonULfrequencyOffset is not configured), the UE may receive the GNSS information of the reference point via SIB1 from the gNB. The UE may calculate u2 based on UE GNSS, reference point GNSS, and satellite ephemeris.

If a cell is fixed on the ground, and if GNSS of a reference point is pre-stored in both the UE and gNB, the UE may read the GNSS information of the reference point from the pre-stored information. The UE may calculate u2 based on UE GNSS, reference point GNSS, and satellite ephemeris.

Besides, PRACH preamble groups are disclosed.

The UE may be configured with a new group of RA resources (e.g., PRACH preamble groups and/or PRACH resources) to support a higher level of UL frequency offsets.

An RRC message configures from a NW to a UE with the following parameters for the UL frequency compensation procedure:

1. PRACHrestrictionSetC: if this Information Element (IE) is present, an RA preamble group is configured;

2. rsrp-ThresholdSSB: an RSRP threshold for the selection of the SSB;

3. UL-frequency-threshold: a threshold for the UL frequency shift.

When the RA resource selection is initiated, the UE selects an SSB if at least one of the SSBs with Synchronization Signal Reference Signal Received Power (SS-RSRP) above rsrp-ThresholdSSB is available. For example, the UE selects an SSB with SS-RSRP above rsrp-ThresholdSSB. Otherwise, the UE may select any SSB. After SSB selection, the UE selects an RA preamble group if PRACHrestrictionSetC is configured and if the estimated or potential UL frequency offset is greater than UL-frequency-threshold. For example, the UE selects the RA preamble group, where the group may contain multiple sets. Otherwise, the UE selects the rest of the RA preamble groups provided in 3GPP Rel-15 NR.

It is noted that a potential UL frequency offset may be determined or estimated by the DL frequency offset measured via DL SSBs, and/or a selected PLMN associated with satellite types (e.g., LEO-600 km, LEO-1200 km, or GEO).

After RA preamble group selection, the UE selects a preamble index. For example, the UE selects an RA preamble randomly with equal probability from the RA preambles associated with the selected SSB and the selected RA preamble group, and sets the PREAMBLE_INDEX for the selected RA preamble.

In one implementation, a new format (e.g., format #1) applied for an RA preamble is selected based on UL-frequency-threshold.

If an estimated or potential UL frequency offset (e.g., UE identifies the required UL frequency offset via DL SSBs or PLMNs) is greater than UL-frequency-threshold, the UE transmits the RA preamble with format #1 with a selected PRACH occasion, the corresponding RA-RNTI (if available), PREAMBLE_INDEX, and PREAMBLE_RECEIVED_TARGET_POWER.

Otherwise, the UE transmits the RA preamble with format #2 with the selected PRACH occasion, the corresponding RA-RNTI (if available), PREAMBLE_INDEX, and PREAMBLE_RECEIVED_TARGET_POWER.

As to maintenance for UL frequency synchronization (in RRC CONNECTED mode), as mentioned in Issue 3, some observations are disclosed.

1. Some limitation may be considered for the value of pre-compensation to prevent the target frequency being out of UE capacity, either restricted by hardware or legal regulations.

2. Performance gain for adding the closed-loop frequency control may be questionable when the pre-compensation and the post-compensation have been deployed at the NW side.

3. If the pre-compensation at the UE side is used, the target UL frequency after pre-compensation may be out of UE capacity regarding hardware limitations and legal regulations.

Based on the observations, the following operations may be applied:

1. The post-compensation at the NW side for both PRACH and the maintenance may be supported.

2. The pre-compensation at the UE side may not be essential if the pre-compensation and the post-compensation are used at the NW side.

3. If the pre-compensation at the UE side is applied, new UE capability reports for UL frequency compensation may be used. Via system information, the NW may indicate which kind of UE (or with what capability) is allowed and can fulfill the requirements of UL frequency compensation to camp on an NTN cell.

In Rel-17 NTN, the UL frequency pre-compensation procedure may be applied. The UE may apply a new UL frequency offset for UL transmission, based on NW assistant information via a cell-specific or UE-specific signal, UE GNSS, and/or satellite ephemeris. The maintenance of the NW assistant information including the Doppler frequency offset u2 may be transmitted via a cell-specific or UE-specific signal (e.g., RRC message, MAC Control Element (CE), Downlink Control Information (DCI)). The validity of the NW assistant information may rely on a timer started or restarted if an update is received by the UE, if a serving cell is disabled, or if a handover procedure is triggered.

In some implementations, when the UE receives the NW assistance information, a validity timer may be started or restarted. The NW assistance information may become invalid if the associated validity timer is expired. The NW assistance information may become invalid if an RRC configuration with synchronization is received/applied (e.g., an HO procedure is performed). The NW assistance information may become invalid if the UE transitions to a different RRC mode (e.g., from RRC CONNECTED mode to RRC IDLE mode).

For a UE in RRC CONNECTED mode, the UE applies the UL frequency compensation procedure for UL transmission (e.g., PRACH, PUCCH, PUSCH, and/or SRS). The UE may suspend or stop any UL transmission if no UL frequency compensation is valid.

In addition, an RRC message configures from a NW to a UE with the following parameters to maintain UL frequency alignment:

1. freqAlignmentTimer: This timer controls how long the UE and/or NW considers a serving cell(s) and/or a group of cells to be uplink-frequency-aligned. For example, the UE may consider the uplink frequency compensation of the serving cell(s) and/or the group of cells valid while the freqAlignmentTimer is running.

Therefore, when a UL frequency update is received by the UE from the NW, the UE may:

1. apply the UL frequency update; and/or

2. start or restart the freqAlignmentTimer.

In addition, when the freqAlignmentTimer expires, the UE may:

1. flush all Hybrid Automatic Repeat Request (HARQ) buffers for the serving cell(s), a group of cells, and/or all serving cells; and/or

2. notify the RRC layer to release PUCCH for the serving cell(s), a group of cells, and/or all serving cells, if configured; and/or

3. notify the RRC layer to release SRS for the serving cell(s), a group of cells, and/or all serving cells, if configured; and/or

4. clear any configured downlink assignments and configured uplink grants; for the serving cell(s), a group of cells, and/or all serving cells; and/or

5. clear any PUSCH resource for semi-persistent channel state information (CSI) reporting for the serving cell(s), a group of cells, and/or all serving cells; and/or

6. consider all running freqAlignmentTimers as expired.

In one example, the freqAlignmentTimer may be configured per cell and/or per group of cells (e.g., a group of cells may be associated with a frequency alignment group (FAG)). More specifically, the FAG may be referred to as a Time Alignment Group (TAG).

In some examples, when the freqAlignmentTimer expires, the UE behavior may be different based on which freqAlignmentTimer expires. For example, if the freqAlignmentTimer is associated with the first type of serving cell(s) or a FAG, the UE may only flush all HARQ buffers, notify the RRC layer to release PUCCH, notify the RRC layer to release SRS, clear any configured downlink assignments and configured uplink grants, clear any PUSCH resources for semi-persistent CSI reporting for the associated serving cell(s) and/or a group of cells. Alternatively, if the freqAlignmentTimer is associated with the second type of serving cell(s) or a FAG, the UE may flush all HARQ buffers, notify the RRC layer to release PUCCH, notify the RRC layer to release SRS, clear any configured downlink assignments and configured uplink grants, clear any PUSCH resources for semi-persistent CSI reporting for all serving cells.

Moreover, when the UL frequency compensation procedure is initiated on a serving cell for UL transmission, and if the freqAlignmentTimer is still running, the UE may:

1. calculate the UL Doppler frequency offset u1 based on UE GNSS and satellite ephemeris;

2. read a UL Doppler frequency offset u2 indicated by the NW;

3. apply the pre-compensation for UL transmission on frequency fpre_comp=f_UL−(u1−u2), where f_UL is a configured UL frequency.

Alternatively, if the freqAlignmentTimer is still running, the UE may not initiate the UL frequency compensation procedure upon the initialization of an RA procedure.

In one example, if the compensated UL frequency is out of UE capability or legal regulation, the UE may ignore the received UL frequency update.

It is noted that the UL frequency update may be implemented by an explicit signal (e.g., an RRC IE, a MAC CE command, or a DCI field indication) from the NW, or by an inexplicit signal from the NW and/or some assistance information (e.g., a new value of the UL Doppler frequency offset u2).

More specifically, the UL frequency update may include the information of a FAG and/or the information for the UE to perform UL frequency compensation. More specifically, the NW may provide a configuration to the UE to indicate a serving cell or a group of serving cells is related to which FAG.

Furthermore, beam-specific parameters for cross-carrier components/cells are disclosed.

In Rel-17 NTN, satellite-beam-specific parameters may be associated with a new list of cell IDs provided by a NW via an RRC configuration. Any update of the beam-specific parameters received from a cell may trigger an update of the parameters in the associated cells of the list.

In one implementation, an RRC message configures from a NW to a UE with the following parameters to enable parameters in multiple cells:

1. simultaneousNTN-CellList: a list of cells for simultaneous NTN-related parameters configuration, reconfiguration, activation, or deactivation.

Therefore, if the UE is provided with simultaneousNTN-CellList, the UE applies the received configuration, command, or indication to all configured cells in a list.

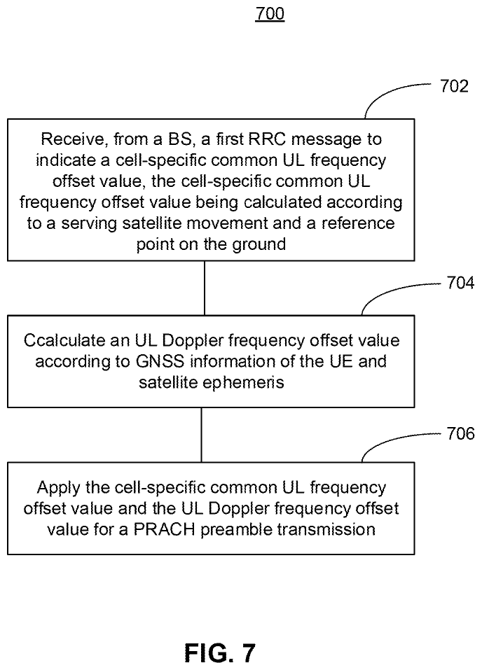

FIG. 7 is a flowchart illustrating a method 700 for a UE to perform an initial access, according to an implementation of the present disclosure. In action 702, the UE receives, from a BS, a first RRC message to indicate a cell-specific common UL frequency offset value (e.g., UL Doppler frequency offset u2), the cell-specific common UL frequency offset value being calculated according to a serving satellite movement and a reference point on the ground. In action 704, the UE calculates a UL Doppler frequency offset value (e.g., UL Doppler frequency offset u1) according to GNSS information of the UE and satellite ephemeris. In action 706, the UE applies the cell-specific common UL frequency offset value and the UL Doppler frequency offset value for a PRACH preamble transmission.

In one implementation, the UE receives, from the BS, a second RRC message to indicate whether a UL frequency compensation procedure for the preamble transmission is needed for a serving cell.

In one implementation, the UE determines that a selected PLMN is associated with an NTN service, and/or determines that the serving cell is an NTN serving cell. The UE applies the cell-specific common UL frequency offset value and the UL Doppler frequency offset value for the PRACH preamble transmission when the UE determines that the selected PLMN is associated with the NTN service or the selected cell belongs to the NTN serving cell, or when the UE determines that the selected PLMN is associated with the NTN service and the selected cell belongs to the NTN serving cell.

In one implementation, the UE receives, from the BS, in the RRC CONNECTED mode, a third RRC message to indicate an SSB decoding procedure that requires additional decoding complexity.

In one implementation, the UE receives, from the BS, a fourth RRC message to indicate geographic information about the reference point on the ground. In one example, the geographic information is updated via broadcast signaling.

In one implementation, the UE receives, from the BS, a fifth RRC message to indicate a new group of PRACH preambles for the PRACH preamble transmission.

In one implementation, the UE receives, from the BS, in the RRC CONNECTED mode, a sixth RRC message to indicate a timer for a validation of a UL frequency compensation value applied for a UL transmission.

In one implementation, the UE receives, from the BS, in the RRC CONNECTED mode, the sixth RRC message to indicate a UL frequency update. The UE applies the UL frequency update and start or restart a timer for indicating the validation of the UL frequency compensation value applied for the UL transmission.

In one implementation, the UE receives, from the BS, a seventh RRC message including a list of cells, and applies the cell-specific common UL frequency offset value for the cells in the list.

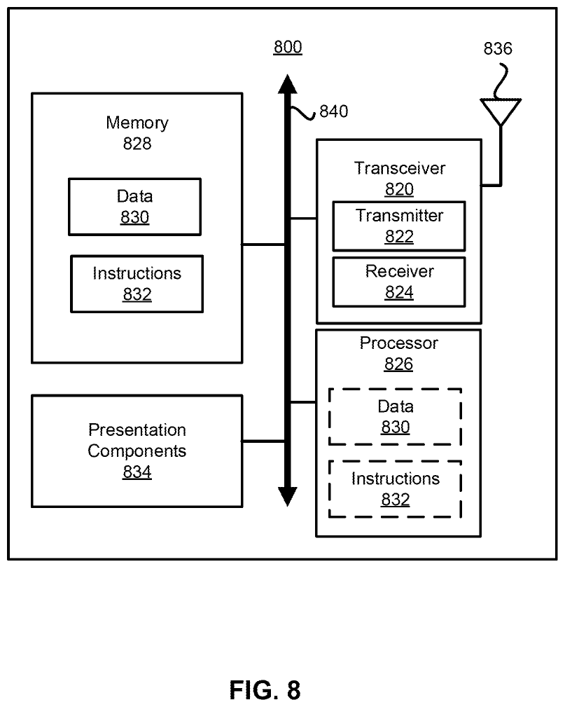

FIG. 8 is a block diagram illustrating a node 800 for wireless communication, according to an implementation of the present disclosure.

As illustrated in FIG. 8, the node 800 may include a transceiver 820, a processor 826, a memory 828, one or more presentation components 834, and at least one antenna 836. The node 800 may also include a Radio Frequency (RF) spectrum band module, a BS communications module, a network communications module, and a system communications management module, input/output (I/O) ports, I/O components, and a power supply (not illustrated in FIG. 8).

Each of these components may be in communication with each other, directly or indirectly, over one or more buses 840. The node 800 may be a UE or a BS that performs various disclosed functions illustrated in FIG. 7.

The transceiver 820 may include a transmitter 822 (with transmitting circuitry) and a receiver 824 (with receiving circuitry) and may be configured to transmit and/or receive time and/or frequency resource partitioning information. The transceiver 820 may be configured to transmit in different types of subframes and slots including, but not limited to, usable, non-usable, and flexibly usable subframes and slot formats. The transceiver 820 may be configured to receive data and control channels.

The node 800 may include a variety of computer-readable media. Computer-readable media may be any media that can be accessed by the node 800 and include both volatile (and non-volatile) media, removable (and non-removable) media. Computer-readable media may include computer storage media and communication media. Computer storage media may include both volatile (and/or non-volatile), as well as removable (and/or non-removable) media implemented according to any method or technology for storage of information such as computer-readable media.

Computer storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media do not include a propagated data signal.

Communication media may typically embody computer-readable instructions, data structures, program modules or other data in a modulated data signal, such as a carrier wave, or other transport mechanisms and include any information delivery media. The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the disclosed media should be included within the scope of computer-readable media.

The memory 828 may include computer-storage media in the form of volatile and/or non-volatile memory. The memory 828 may be removable, non-removable, or a combination thereof. For example, the memory 828 may include solid-state memory, hard drives, optical-disc drives, etc. As illustrated in FIG. 8, the memory 828 may store computer-readable and/or computer-executable instructions 832 (e.g., software codes) that are configured to, when executed, cause the processor 826 (e.g., processing circuitry) to perform various disclosed functions. Alternatively, the instructions 832 may not be directly executable by the processor 826 but may be configured to cause the node 800 (e.g., when compiled and executed) to perform various disclosed functions.

The processor 826 may include an intelligent hardware device, a central processing unit (CPU), a microcontroller, an ASIC, etc. The processor 826 may include memory. The processor 826 may process the data 830 and the instructions 832 received from the memory 828, and information through the transceiver 820, the baseband communications module, and/or the network communications module. The processor 826 may also process information to be sent to the transceiver 820 for transmission via the antenna 836, to the network communications module for transmission to a CN.

One or more presentation components 834 may present data to a person or other devices. Presentation components 834 may include a display device, a speaker, a printing component, a vibrating component, etc.

From the present disclosure, it is evident that various techniques can be utilized for implementing the disclosed concepts without departing from the scope of those concepts. Moreover, while the concepts have been disclosed with specific reference to specific implementations, a person of ordinary skill in the art would recognize that changes can be made in form and detail without departing from the scope of those concepts. As such, the present disclosure is to be considered in all respects as illustrative and not restrictive. It should also be understood that the present disclosure is not limited to the specific disclosed implementations, but that many rearrangements, modifications, and substitutions are possible without departing from the scope of the present disclosure.

1-16. (canceled)

17. A method for a user equipment (UE) operating in a non-terrestrial network (NTN), the method comprising:
receiving, from a base station (BS), assistance information;
starting or restarting a first timer upon receiving the assistance information;
applying the assistance information to perform uplink synchronization; and
determining that the UE has lost the uplink synchronization upon expiration of the first timer.

18. The method of claim 17, further comprising:
determining that the assistance information is invalid upon the expiration of the first timer.

19. The method of claim 17, further comprising:
treating other running timers associated with the uplink synchronization as expired upon the expiration of the first timer.

20. The method of claim 17, further comprising:
flushing all hybrid automatic repeat request (HARQ) buffers for at least one serving cell upon the expiration of the first timer.

21. The method of claim 17, further comprising:
notifying a radio resource control (RRC) layer of the UE to release a physical uplink control channel (PUCCH) for at least one serving cell upon the expiration of the first timer.

22. The method of claim 17, further comprising:
notifying a radio resource control (RRC) layer of the UE to release a sounding reference signal (SRS) for at least one serving cell upon the expiration of the first timer.

23. The method of claim 17, further comprising:
clearing a configured downlink assignment and a configured uplink grant for at least one serving cell upon the expiration of the first timer.

24. The method of claim 17, further comprising:
clearing a physical uplink shared channel (PUSCH) resource for semi-persistent channel state information (CSI) reporting for at least one serving cell upon the expiration of the first timer.

25. A user equipment (UE) operating in a non-terrestrial network (NTN), the UE comprising:
a processor for executing a computer-executable program; and
a memory, coupled to the processor, for storing the computer-executable program that, when executed by the processor, causes the UE to:
receive, from a base station (BS), assistance information;
start or restart a first timer upon receiving the assistance information;
apply the assistance information to perform uplink synchronization; and
determine that the UE has lost the uplink synchronization upon expiration of the first timer.

26. The UE of claim 25, wherein the processor is further configured to execute the computer-executable program to cause the UE to:
determine that the assistance information is invalid upon the expiration of the first timer.

27. The UE of claim 25, wherein the processor is further configured to execute the computer-executable program to cause the UE to:
treat other running timers associated with the uplink synchronization as expired upon the expiration of the first timer.

28. The UE of claim 25, wherein the processor is further configured to execute the computer-executable program to cause the UE to:
flush all hybrid automatic repeat request (HARQ) buffers for at least one serving cell upon the expiration of the first timer.

29. The UE of claim 25, wherein the processor is further configured to execute the computer-executable program to cause the UE to:
notify a radio resource control (RRC) layer of the UE to release a physical uplink control channel (PUCCH) for at least one serving cell upon the expiration of the first timer.

30. The UE of claim 25, wherein the processor is further configured to execute the computer-executable program to cause the UE to:
notify a radio resource control (RRC) layer of the UE to release a sounding reference signal (SRS) for at least one serving cell upon the expiration of the first timer.

31. The UE of claim 25, wherein the processor is further configured to execute the computer-executable program to cause the UE to:
clear a configured downlink assignment and a configured uplink grant for at least one serving cell upon the expiration of the first timer.

32. The UE of claim 25, wherein the processor is further configured to execute the computer-executable program to cause the UE to:
clear a physical uplink shared channel (PUSCH) resource for semi-persistent channel state information (CSI) reporting for at least one serving cell upon the expiration of the first timer.
